(19) United States
(12) Patent Application Publication
(10) Pub. No.: US 2012/0183376 A1
(43) Pub. Date: Jul. 19, 2012

(54) SYSTEM FOR EXTRACTION AND TRANSPORT OF LIGHT ASHES BY MEANS OF A STEEL BELT CONVEYOR

(76) Inventor: Mario Magaldi, Salerno (IT)

(21) Appl. No.: 13/497,356

(22) PCT Filed: Aug. 31, 2010
(86) PCT No.: PCT/IB10/53902

§ 371 Date: Apr. 9, 2012

(30) Foreign Application Priority Data
Sep. 24, 2009 (IT) RM2009A000488

(51) Int. Cl. F23J 3/00; B65G 17/06

(52) U.S. Cl. 414/196; 414/209

(57) ABSTRACT

A transport apparatus for dry extraction and transport of fly ashes produced inside solid fuel boilers, adapted to be associated with a fume dedusting system and including: a metal belt conveyor, having a plurality of slats partially overlapped, adapted to support a bed of fly ashes to transport the bed along a preset path, and a sealed metal casing inside which the slats move; and containment means for fly ashes, adapted to confine the ashes on the slats and along the transport path so as to limit relative motion between ashes and conveyor, which means comprises transverse boards, leveling members, side boards and a movable rear baffle.

### FIELD OF THE INVENTION

The present invention refers to a system for dry extraction and transport of light ashes produced inside solid fuel boilers, where the transport system is based on a belt conveyor, preferably made of steel.

### BACKGROUND OF THE INVENTION

Coal ashes are the product of a transformation undergone by mineral impurities, above all silica, present in fossil fuel following its combustion in thermoelectric plants. Overall, such impurities form a fraction that melts in the combustion chamber, giving rise to minuscule droplets. The latter, entrained by fumes, at the boiler outlet undergo a sudden cooling and solidify in the form of vitreous particles of spheroid shape. Dust abatement systems then purify the fumes, separating therefrom these ashes that are defined “light” or “fly” ashes, to tell them apart from that minor fraction of impurities that, by agglomerating, falls directly on the boiler bottom (“heavy” ashes)

Known systems for dedusting combustion fumes exploit mechanical (as in the so-called “sleeve filters”) or electrostatic collection systems in order to obtain said separation of light ashes. The latter precipitate into suitable accumulation hoppers set at the bottom of the separation system. From said hoppers, light ash is then typically evacuated by gravity and fed to the transport system.

It should be noted that fly ashes have an average grain size ranging between 10 and 50 microns, low bulk density and low friction coefficient, and are extremely abrasive. Owing to these features, they are extremely difficult to move downstream of the dedusting systems, both as hardly containable and owing to the high dustiness determined during said moving, especially at the hopper loading and unloading points. Moreover, said ashes subject transport machine components to marked wear.

In the known art, dry extraction and transport of fly ashes from systems for separating combustion fumes are typically carried out by pneumatic transport systems, and sometimes by drag-chain conveyors.

Chain conveyors—generally based on a system of vanes apt to push ash to a collection point and driven just by moving chains—entail the drawback of being subjected to wear consequent to relative motion of the highly abrasive material on the components of the conveyor itself, such as conveying chains, scrapers, casing bottom and walls. The unforeseen failure of even a single element of a chain conveyor causes a sudden stop of the entire transport system, and therefore an interruption of the production of upstream and downstream systems for the time needed for maintenance or replacement of the damaged component.

Pneumatic moving systems are generally more reliable than the above chain systems, but consume far more power than the latter, having to move ashes, as well as transport air, and wear out more quickly in areas where ash grazes against transport pipes, valves and ejectors, due to the high rates required for pneumatic transport. The effects of such wears are usually delayed by costly coatings of ceramic materials and with the use of basalt components located in the points of higher impact of the material along the transport duct, usually made of steel or special high-manganese cast irons. Pneumatic systems entail remarkable energy consumption, due also to the power needed to grant the head useful for ash transport to the end storage silo or to other sites for subsequent ash treatment, and identify a complex system, also due to the presence of minor dedusting systems associated to the spent stream of transport air.

### SUMMARY OF THE INVENTION

Hence, the technical problem set and solved by the present invention is to provide an apparatus and a method for transport of fly (light) ashes allowing to overcome the drawbacks mentioned above with reference to the known art.

Such a problem is solved by an apparatus according to claim 1 and a method according to claim 22.

Preferred features of the present invention are set forth in the dependent claims thereof.

According to the invention and its preferred embodiments described hereinafter, fly ashes, transported by combustion fumes and separated therefrom by dedicated abatement systems, are recovered from hoppers of said abatement systems by an exclusively mechanical system for dry transport, and transported, always mechanically, to the end collection silo or other dedicated transport or treatment systems.

The present invention provides several relevant advantages.

First of all, the system drastically limits or eliminates relative motion between transported ashes and mechanical transport components, thereby reducing to a very significant extent or totally excluding all of the above-illustrated wear problems, associated both to known mechanical systems and to pneumatic ones.

Moreover, energy expenditures and system complexities associated to the use of known-art pneumatic transport systems are avoided.

An association of the present invention to mechanical dry extraction systems for heavy ashes of the type described in EP 0 471 055 is particularly advantageous.

Moreover, in a preferred embodiment a crushing of heavy ashes dry-recovered from the boiler bottom and their recycling in the boiler through pre-existing systems for fuel pulverizing and feeding to the combustion chamber are provided. In such a configuration, heavy ashes undergo a grain size reduction allowing, following a subsequent transit through the combustion chamber along with the pulverized fossil fuel, to transform them into light ashes collected by combustion fume separation systems and dry-extracted from the latter jointly with other fractions of fly ashes.

In-boiler recycling of pulverized heavy ashes allows a remarkable reduction of the content of unburnt matters present therein. The reduction of unburnt matters in the heavy ashes thus treated, associated to grain size reduction and to the circumstance that, entrained by fumes, they are collected by the separation systems, allows—also due to the dilution effect operated to the other ash fraction—to lower the total percent of unburnt matters of light ashes and to make the latter suitable (according to the laws in force for their use) in the production of cement and concrete, avoiding drawing on the heritage of natural resources, above all limestone and pozzolana, obtained from dedicated quarries.

With regard to this latter aspect, the following should be noted. Limestone and pozzolana, mixed to other mineral components, are burnt in cement factory kilns to obtain cement clinker which, suitably ground, becomes actual cement. Production of one ton of clinker generates about 1 ton of CO₂. Good-grade fly ashes, i.e., having a <5% b/w percent of unburnt matters, may be added to up to 30% cement clinker. Operating this replacement could save millions of tons of CO₂ each year.

Hence, the above-mentioned configuration singles out an integrated system allowing transformation of all ashes produced inside the boiler into light (fly) ashes and subsequent mechanical transport into a unified transport and storage system, drastically reducing complexity and investment cost, and absorbed power value.

Preferably, in the above-mentioned configuration it is also provided a recycling of the ashes extracted from the economizers and the air/fume exchanger downstream of the latter and of an optional crushing thereof.

The advantages associated to the integrated/unified ash management system become more relevant with the increasing both of the flow rate of total ash produced by the boiler, and of the distance of transport to the end storage site.

Other advantages, features and operation steps of the present invention will be made apparent in the detailed description of some preferred embodiments thereof, given by way of example and not for limitative purposes.

### BRIEF DESCRIPTION OF THE FIGURES

Reference will be made to the figures of the annexed drawings, wherein:

FIG. 1 shows a general diagram of a preferred embodiment of the apparatus of the invention;

FIG. 1A shows an enlarged detail of the diagram of FIG. 1, incorporating also a variant thereto;

FIG. 2 shows a sectional view of the extractor of the apparatus of FIG. 1, taken along line A-A of the latter figure;

FIG. 2A shows the same sectional view of FIG. 2, yet referring to the variant of FIG. 1A and taken along line B-B of the latter;

FIGS. 3 and 3A show a perspective view of a detail of the conveyor belt of the apparatus of FIG. 1;

FIG. 4, obtained from FIG. 1, schematically shows a loading point between separation system hopper and extractor of the apparatus according to the preferred embodiment of the invention considered herein.

FIG. 5 shows an integrated diagram of a further preferred configuration of the system of FIG. 1, in which it is provided a system for extraction, pulverizing and recycling of heavy ash and ash from the economizers and the air/fume exchanger; and

FIG. 6 shows a top view of a detail of the diagram of FIG. 6, related to extraction of fly (light) ashes from precipitators.

### DETAILED DESCRIPTION

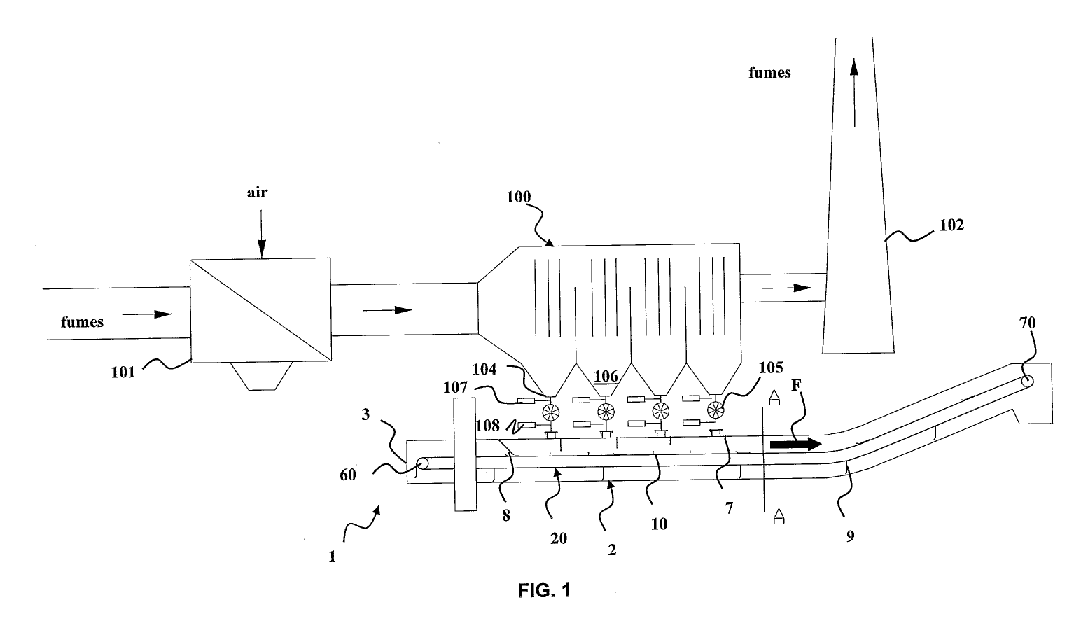

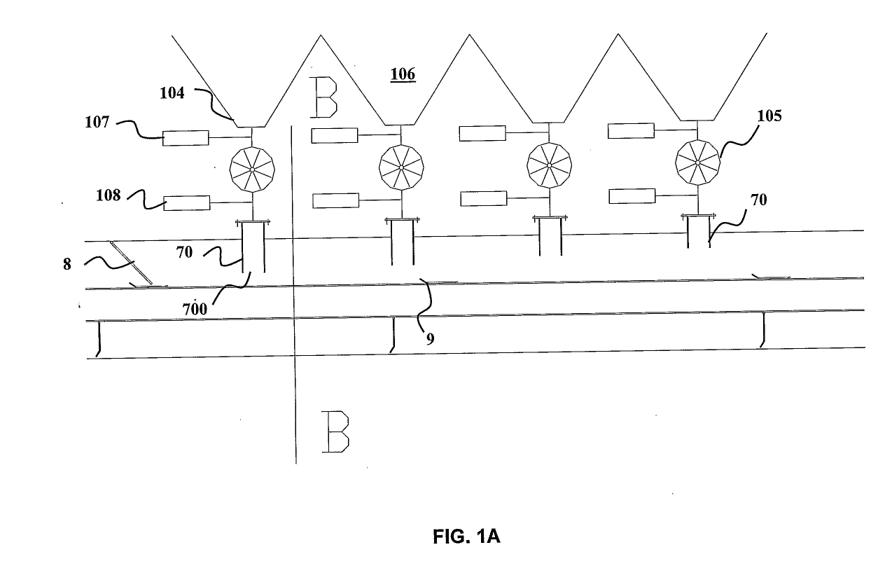

Referring initially to FIG. 1, an apparatus for dry transport of fly (light) ashes produced inside solid fuel boilers according to a preferred embodiment of the invention is generally denoted by 1.

The apparatus 1 is associated to a system for dedusting combustion fumes generated inside said boiler, generally denoted by 100, which in the present example is of the type employing an electrostatic principle for the separation of fly ashes from the fumes themselves.

In FIG. 1, apparatus 1 and system 100 are depicted as inserted in a typical context of an installation envisaging an air/fume exchanger 101 and a fumes exhaust stack 102, arranged respectively upstream and downstream of the fumes separation system 100.

The apparatus 1 comprises first of all a metal belt 20 type conveyor 2, in particular made of steel. The belt 20 is apt to convey the fly ashes extracted from the fume dedusting system 100 to a storage, treatment and/or disposal site, and is enclosed in a sealed metal casing 3 preventing discharges of fly ashes into the environment during their transport.

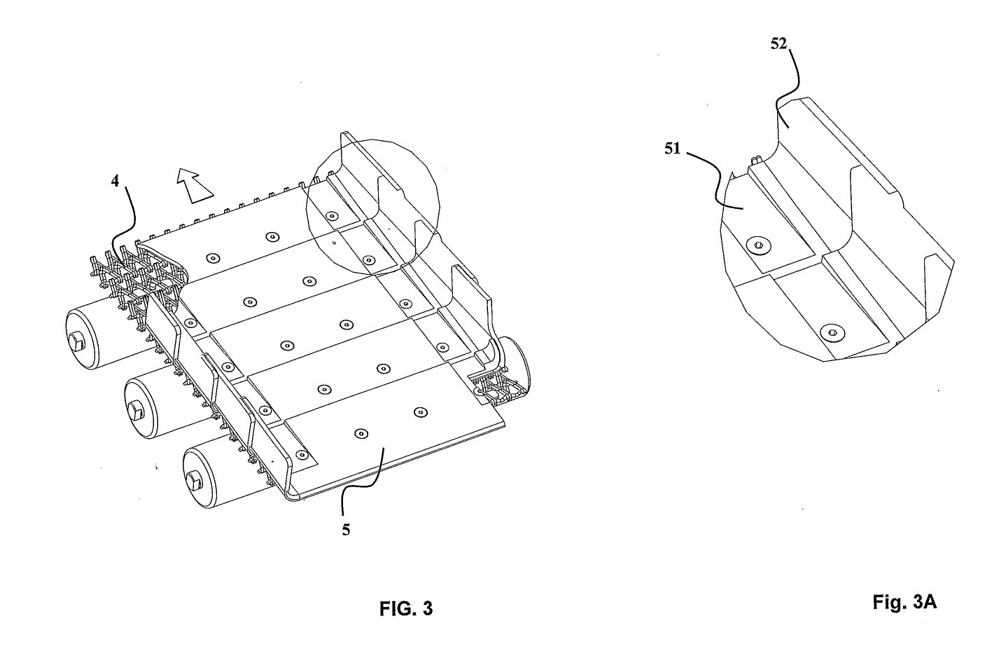

As shown in greater detail in FIGS. 3 and 3A, in the present exemplary embodiment the conveyor belt 20 is of the type comprising a metal mesh belt 4 supporting a plurality of adjacent or partially overlapped slats, one of which exemplarily denoted by 5. The slats 5 are then moved integrally to the mesh belt 4 according to an annular path obtained by control and transmission drums 60 and 70, the latter schematically depicted in FIG. 1.

The slats 5 are apt to support a bed of fly ashes to transport them along a preset path corresponding substantially to the top horizontal travel of the belt 20, along arrow F of FIG. 1.

Fly ashes are fed by the separation system 100 on the belt 20 at multiple outlets of the former, implementing as many loading points arranged in sequence along the transport path. One of said outlets is denoted, by way of example, by 104.

At each outlet 104, feeding is metered by means of cyclically operating (closing) valves 105 and/or equivalent means arranged in the interface points between accumulation hoppers 106 of the dedusting system 100 and casing 3 of the conveyor 2.

Upstream and downstream of each feeding valve 105 automatic or manual sectioning devices 107, 108 are provided, apt to allow/prevent ashes discharge onto the slats 5.

According to the invention, the apparatus 1 further comprises containment means for fly ashes, apt to confine the latter on the conveyor belt and along said transport path. Preferably, such containment means is multiple.

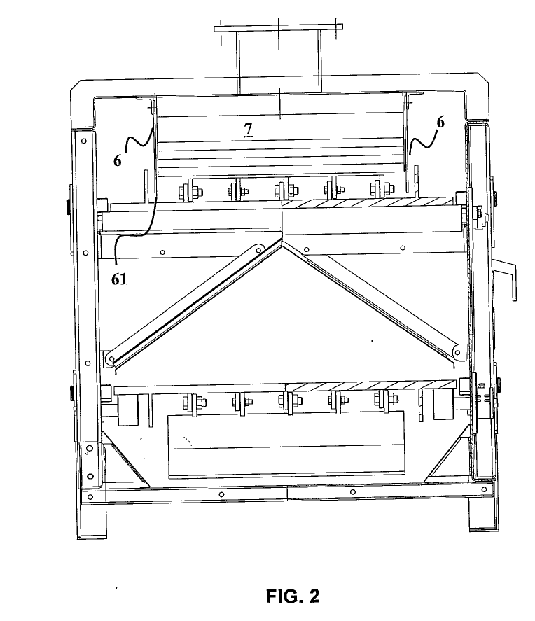

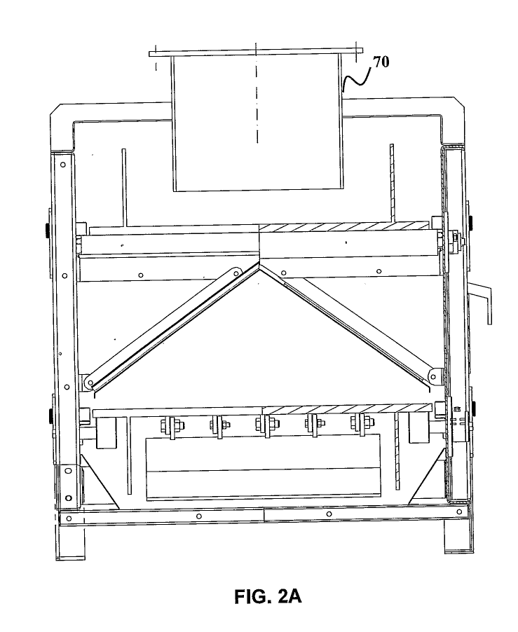

In particular, the above-mentioned means comprises fixed side boards 6 integral to the casing 3 and better observed in FIG. 2. The boards 6 are arranged along the transport path, at both ends of the slats 5, and extend in a direction substantially orthogonal to the latter and substantially parallel to the direction of transport F. As schematically shown in FIG. 2, the bottom edge 61 of the boards 6 brushes the slats 5 during their advancement.

By virtue of their own structure and arrangement, which brushes the surface of the belt 20, the boards 6 prevent lateral discharges of fly ashes during transport.

As shown in greater detail in FIGS. 3 and 3A, preferably the slats 5 have dedicated lateral seats 51 apt to receive the bottom edge 61 of the side boards 6, which seats may, for example, be made in the form of guides, grooves or longitudinal tracks and, again by way of example, obtained by milling.

Moreover, preferably the side boards 6 are arranged internally with respect to side slats 52 provided on the transport slats 5, so as to make therewith a sort of labyrinth seal for the fly ashes.

Such a coupling between seats 51 of the slats 5, bottom edges 61 of the boards 6 and side slats 52 of the slats 5 themselves optimizes sealing to fine material, containing it in the transport zone.

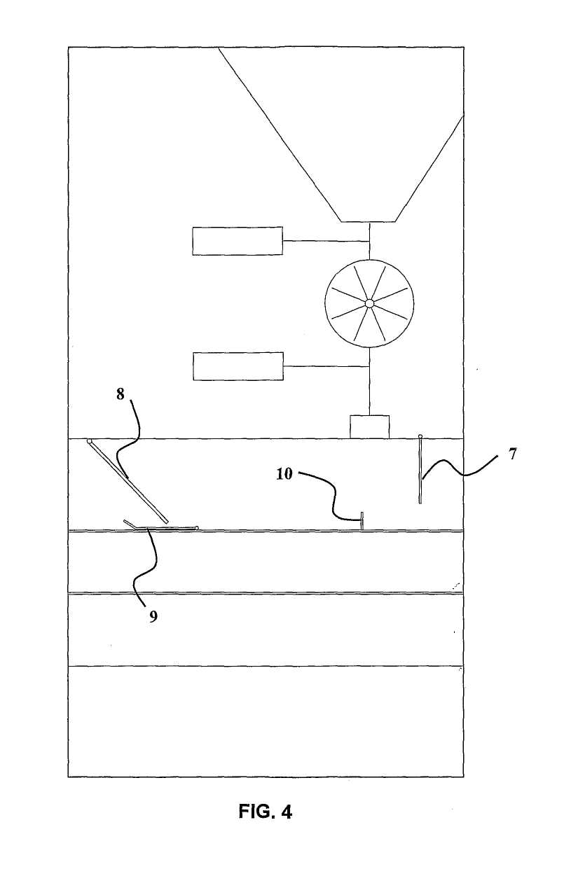

The containment means of the present embodiment further provides a plurality of layer adjustment means in the form of leveling members of the ash bed laid on the slats 5, better observed in FIGS. 2 and 4, and one of which exemplarily denoted by 7. Each leveling member 7 is arranged at or near to a respective loading point 104 of the conveyor 2 and extends above the slats 5 in a direction substantially orthogonal thereto.

In the present example, for each leveling member 7 a fixed or movable gate implementation is provided mounted on the casing 3.

For each feeding (loading) point 104, the leveling members 7 determine an appropriate layer height, associated to the amount of material fed in that point in addition to the fine material already present in the transport section preceding the reference loading point.

Ash containment on the belt associated to the various feeding (loading) points may alternatively be carried out by relating the conveyor belt rate with the rotation rate of the cyclically operating valves, or by a combination of the two solutions considered.

The containment means of the present embodiment then provides a rear interdiction means 8, arranged upstream of all loading points 104 and apt to prevent a flow of ashes in a direction opposite to that of transport. Such an interdiction element 8 is made in the form of a transverse closure baffle taking up the entire transport section of the slats 5. Preferably, the rear baffle 8 is movable and hinged on the casing 3 of the extractor 2 and apt to be selectively operated.

The rear transverse baffle 8 is apt to second the travel direction of the belt 20, and by means of lateral supports is held at a short distance from the transport surface of the slats 5. Thus, ash present in the first transport section and that, owing to its own physical properties and the lateral thrust undergone by the same material at he subsequent loading sections, would tend to slide into the bordering rear section, is held by said baffle 8 while the conveyor belt 20 imparts thereto the direction and sense of motion F.

As mentioned above, the rear containment baffle 8 may be mechanically operated and rise in a timed mode or by proximity sensor.

In particular, in the present embodiment said operation serves to allow transit of fines recovery scrapers, provided on the belt 20 and one of which exemplarily denoted by 9 in the figures.

Such fines recovery scrapers may, e.g., be made according to the teachings of EP 1 409 380, being hinged on the belt 20 and apt to assume a raised configuration substantially orthogonal to the belt itself in the return stroke, so as to be able to drag the fines deposited on the bottom of the container 3, and a laying configuration in the forward stroke, i.e., along the transport path of fly ashes. This dual configuration is schematically depicted in FIG. 1.

Alternatively, the system for recovering fines from the bottom of the conveyor may be manual or determined by an operator via external suction systems connectible with dedicated prearrangements of the conveyor bottom; in that case, no recovery element is associated to the conveyor belt.

The containment means of the present embodiment also provides a plurality of transverse boards 10, integral to the slats 5 and arranged at regular intervals on the latter. The transverse boards 10 extend in a direction substantially orthogonal to that of transport and are apt to prevent a motion of the ashes in a sense contrary to that of motion of the slats 5.

The transverse boards 10 improve transport of fine material also in the presence of tilted sections of the belt 20, in this case slowing down fine material in the non-horizontal section.

The transverse boards 10 may be made in the form of metal reliefs.

Height and number of said boards 10 are determined depending on the layer of material expected in the transport zone, and on the tilt of the conveyor 2.

The present embodiment also comprises a system for adjusting the pressure internal to the environment inside the casing 3 of the conveyor 2.

In particular, in the present example the environment inside the casing 3 is maintained under a slight negative pressure with respect to atmosphere by connection of one or more points of the conveyor 2 with the environment of the dedusting system 100. Said suction points may advantageously be in the neighborhood of the loading zones 104 and/or the unloading section of the belt 20. The connecting ducts may be equipped with automatic or manual adjustment/sectioning devices in order to adjust the negative pressure occurring inside the conveyor 2, or, optionally, to eliminate it. The slight negative pressure determined in the casing 3 of the conveyor 2 has the object of minimizing the accumulation of fine material out of the top transport zone, accumulation that would ensue following dust raising during feeding (loading) and unloading steps.

FIGS. 1A and 2A refer to a variant of the configuration of the containment means described hereto, particularly useful in case ash flow rate is limited. Referring to said figures, fly ash runners arranged downstream of the valves 105 and of the sectioning devices 108, one of which exemplarily denoted by 70, may themselves act as layer levelers in lieu of the leveling members 7 of the preceding embodiment. To this end, their longitudinal extension may be extended with respect to the preceding case, so as to move the outlet 700 nearer to the transport surface of the belt 20. Thus, the distance of said outlet 700 from the slats 5 determines the height of the ash layer that is to be obtained.

In this configuration, the side slats 52 of the slats 5 are sized for the maximum layer of ash and the various loading points of the belt 20, made at the outlets 700, are arranged at increasing heights from the transport surface, along the direction of transport F, in order to envisage the amount of ash fed by the preceding loading points, analogously to what can be obtained with the members 7 of FIG. 1.

A further variant of the configuration of FIGS. 1 and 2, not illustrated, foresees an association of the containment boards 6 to the runners 70 with the function of layer levelers according to the aforedescribed modes, in replacement of the leveling baffles 7.

For the preceding configuration variants as well, the feed rate of the automatic cyclically closing (operating) valves may be related to the advancement rate of the conveyor belt.

Therefore, it will be understood that the containment means described hereto operate to contain movements of fly ashes, both in a lateral sense and in a direction of transport, as well as in general, by maintaining the environment inside the conveyor under a slight negative pressure, to eliminate dispersion of any dust outside of the system, to contain the actual volatility and mobility of the ashes transported on the belt 20 and, lastly, by the levelers 7, 70, to create a uniform bed of ashes. Thus, fly ash containment in the top transport zone of the belt 20 is maximized, and the risk that fly ash may rise from the transport section during the steps of loading and of transport itself is eliminated.

By now, it will be better appreciated that the invention solves the problems of the known art related to the containment of fly ashes, and allows a mechanical transport of said ashes without undergoing wear and in total respect of the environment, both in terms of dispersion of the dusty material and of transport-associated energy consumptions.

On the basis of variant embodiments and according to layout needs, to the above-described main extractor 2 one or more ancillary mechanical conveyors may be associated, arranged downstream thereof, optionally of the same typology or of the metal bucket elevator type. Such ancillary conveyors may provide light (fly) ash transport to the main storage silo or to further treatment systems for light (fly) ashes preceding the storage step.

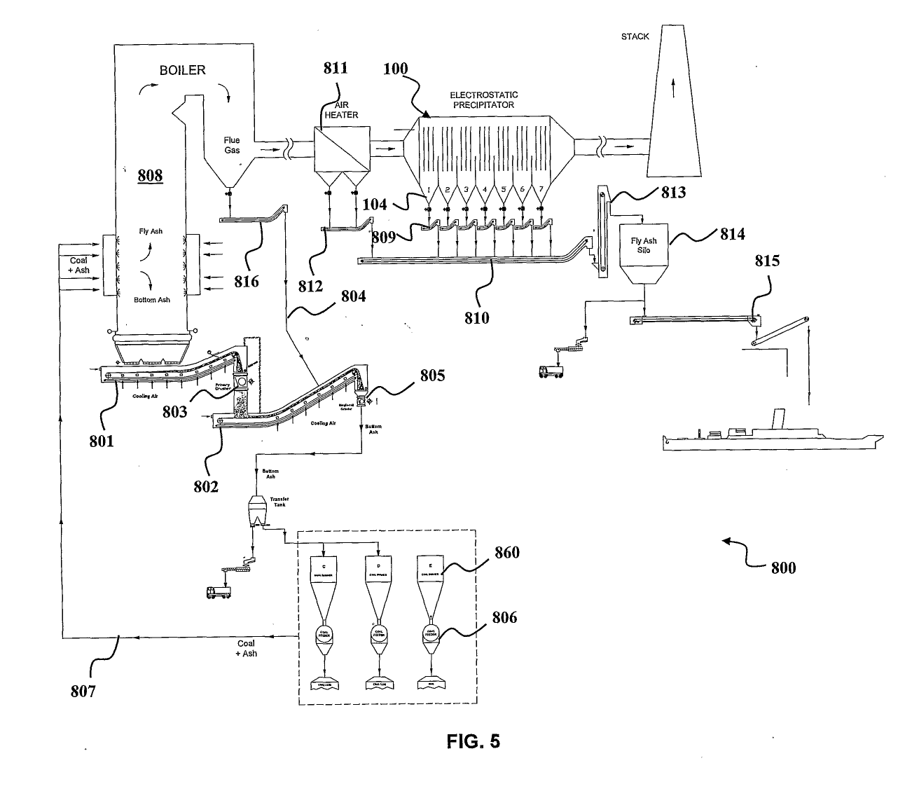

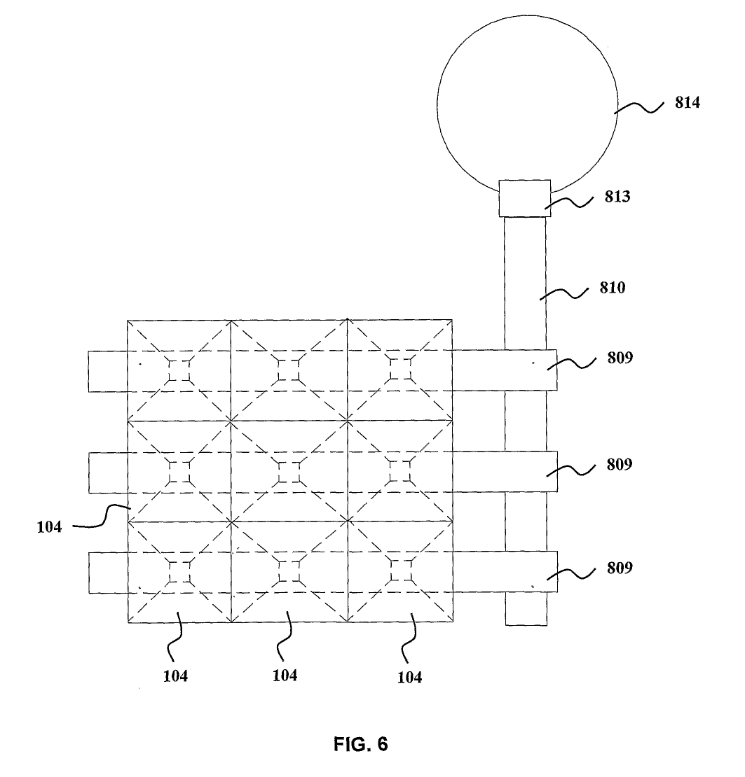

FIGS. 5 and 6 show a particularly advantageous system configuration in association with the hereto-described apparatus 1.

Referring to said figures, the depicted configuration provides a combination of the mechanical transport apparatus according to the present invention with systems for extraction, pulverization and recycling in the combustion chamber of heavy ashes and of those coming from economizers and air/fume exchanger. As already mentioned, this combination singles out an integrated mechanical transport system outputting solely high-grade fly ashes as an exclusive product of the boiler.

Going into further detail, the above-mentioned system is generally denoted by 800.

Heavy ashes are dry extracted from the throat of the boiler 808 by means of a belt extractor 801, of the same type described in EP 0 471 055.

In the example of FIG. 5, the above-mentioned main extractor 801 and a post-cooler conveyor 802 are provided, arranged in sequence and separated by a crushing stage 803, according to the configuration described in EP 0 471 055.

Furthermore, the post-cooler 802 is in communication, through suitable means generally denoted by 804, with the economizer's zone, so that a portion of ashes may be collected from the latter and fed just to the environment of the second conveyor 802. Such means 804 also envisages a dry extractor 816 of the type already introduced hereto.

The heavy ashes transported on the second conveyor 802, mixed to the fly ashes fed by the means 804, are then unloaded from the conveyor 802 itself and preferably fed to a further crushing stage 805.

Downstream of the latter, ash may be inlet into one or more coal bunkers 860 or other storage means for subsequent use, or, alternatively, directly metered to one or more pre-existing pulverizing mills 806. Inside the mills 806, fuel-admixed ashes are pulverized and inlet, along with the fuel, into the combustion chamber 808 through pre-existing feeding systems 807.

Downstream of the combustion chamber 808, said ashes are transformed into fly ashes, entrained by combustion fumes and collected by the separation means 100.

In the example depicted in FIG. 5, to each loading point 104 of separation system 100 a specific dry conveyor 809 of the type already described is associated, which alternatively may also enslave plural loading points 104 as illustrated in FIG. 6.

A collector conveyor 810, always of the type already introduced, receives the fly ashes fed by each individual conveyor 809.

It will be appreciated that, on the basis of the variant shown in FIG. 5, it is also provided an extraction of ashes from the air/fume exchanger 811—fume side—usually present in installations of the type considered.

Such extraction as well occurs with modes and means analogous to the ones already described with reference to the embodiment of FIG. 1 at the loading points 104, and in particular by a further ancillary conveyor 812 of the type already introduced, which feeds the extracted ash on the collector conveyor 810.

Downstream of the collector conveyor 810 the transport sequence, depending on available encumbrances and system layout, goes on with mechanical transport means such as elevators or rubber belts 813 for the loading of intermediate storage silos or of end storage silos 814 and from the latter, always by mechanical transporters 815, can directly feed the load on a ship in case of a transport of fly ashes by sea.

The present invention has been hereto described with reference to preferred embodiments thereof. It is understood that other embodiments might exist, all falling within the concept of the same invention, as defined by the protective scope of the claims hereinafter.

1-24. (canceled)

25. A system for dry extraction and transport of fly ashes entrained by combustion fumes and produced inside solid fuel boilers, comprising:
a fume dedusting system carrying out separation of said fly ashes from the fumes; and
a dry transport apparatus, arranged downstream of said dedusting system, the dry transport apparatus comprising:
a metal belt conveyor, having a plurality of adjacent slats, possibly partially overlapped, adapted to support a bed of fly ashes to transport the bed along a preset path, and a sealed casing inside which said slats move; and
containment means of the fly ashes, adapted to confine the fly ashes on said slats and along said transport path so as to limit relative motion between ashes and slats both in a direction of transport and transversally thereto.

26. The system according to claim 25, comprising means for ashes feeding or interdicting interposed between said dedusting system and said conveyor, preferably upstream and/or downstream of flow rate adjustment means, and adapted to allow or prevent ashes discharge from the dedusting system to the transport apparatus.

27. The system according to claim 25, wherein said containment means comprises a pair of fixed side boards arranged parallel to said transport path and extending in a direction substantially orthogonal to said slats, which side boards each have a bottom edge brushing said slats so as to prevent lateral discharges of transported fly ashes.

28. The system according to claim 27, wherein said slats have a pair of dedicated lateral seats adapted to receive respective bottom edges of said fixed side boards.

29. The system according to claim 25, wherein said slats have a pair of raised side wings preferably external to said fixed side boards so that overall a sort of labyrinth seal is made for the fly ashes.

30. The system according to claim 25, wherein said containment means comprises one or more leveling members of the ash bed laid on said slats.

31. The system according to claim 30, wherein each of said leveling members is mounted on said casing and is adapted to be arranged at or near a respective loading point of said conveyor, and wherein each of said leveling members extends above said slats in a direction substantially orthogonal thereto.

32. The system according to claim 31, wherein said or each leveling member comprises a fixed or movable gate means.

33. The system according to claim 31, wherein said leveling members are made by ash feeding channels.

34. The system according to claim 31, wherein said leveling members are arranged along said transport path at increasing distance from the transport surface of said belt.

35. The system according to claim 25, wherein said containment means comprises a transversal interdiction means mounted on said casing upstream of the loading point or points of said conveyor and adapted to prevent a flow of ashes in a direction opposite to that of transport.

36. The system according to claim 35, wherein said transversal interdiction means comprises a movable transverse baffle.

37. The system according to claim 25, wherein said conveyor comprises a plurality of fines recovery elements for recovering fines from the bottom of the conveyor itself, preferably in form of scrapers associated to an integrated fines recovery system.

38. The system according to claim 37, wherein said transversal interdiction means comprises a movable transverse baffle, said movable transverse baffle being selectively operable to allow transit of said fines recovery elements.

39. The system according to claim 25, wherein said containment means comprises a plurality of transverse boards integral to said slats and arranged at preset intervals on said slats.

40. The system according to claim 25, wherein said containment means comprises a system allowing to maintain an environment of said conveyor inside said casing under a slight negative pressure with respect to outside environment.

41. The system according to claim 25, wherein the metal conveyor belt comprises a metal mesh supporting a plurality of adjacent or partially overlapped metal slats.

42. A system for dry extraction and transport of ashes produced inside solid fuel boilers, comprising:
the system for dry extraction and transport of fly ashes according to claim 25;
a metal belt conveyor, having a plurality of adjacent slats, optionally partially overlapped, adapted to support a bed of heavy ashes to transport the bed along a preset path, and a sealed casing inside which said slats move, which conveyor is arranged or apt to be arranged at the bottom of a boiler;
a system for crushing said heavy ashes, arranged downstream of said conveyor; and
means for feeding crushed ashes into the boiler, the overall arrangement being such that said heavy ashes crushed and recycled in the boiler are then transported by said dry transport apparatus.

43. The system according to claim 42, further comprising means for feeding ashes, extracted at an economizers level, to said belt conveyor for heavy ashes.

44. The system according to claim 42, further comprising means for feeding ashes, extracted at a level of an air/fumes exchanger arranged downstream of the boiler, to said belt conveyor for fly ashes of said transport apparatus.

45. A method of dry extraction and transport of ashes produced inside solid fuel boilers, comprising:
extracting fly ashes from a fume dedusting system by the transport system according to claim 25;
dry extracting heavy ashes by a metal belt conveyor, having a plurality of adjacent slats, optionally partially overlapped, apt to support a bed of heavy ashes to transport it along a preset path, and a sealed casing inside which said slats move, which conveyor is arranged at the bottom of a boiler; and
crushing said heavy ashes and recycling thereof in the boiler,
so that said heavy ashes crushed and recycled in the boiler are then transported by said dry transport apparatus.

46. The method according to claim 45, further providing feeding of ashes, extracted at an economizers level, to said belt conveyor for heavy ashes.

47. The method according to claim 45, further providing feeding of ashes, extracted at a level of an air/fume exchanger arranged downstream of the boiler, to said belt conveyor for fly ashes of said transport apparatus.

48. A transport apparatus for dry transport of fly ashes entrained by combustion fumes and produced inside solid fuel boilers, adapted to be associated with a fume dedusting system carrying out separation of said fly ashes from the fumes themselves, comprising:
a metal belt conveyor, having a plurality of adjacent slats, optionally partially overlapped, adapted to support a bed of fly ashes to transport the bed along a preset path, and a sealed casing inside which said slats move; and
containment means for fly ashes, adapted to confine the fly ashes on said slats and along said transport path so as to limit relative motion between ashes and slats both in a direction of transport and transversally thereto,
wherein said containment means comprises:
a pair of fixed side boards arranged parallel to said transport path and extending in a direction substantially orthogonal to said slats, which side boards have each a bottom edge brushing said slats so as to prevent lateral discharges of transported fly ashes;
a pair of raised side wings of said slats, external to said fixed side boards so that overall a sort of labyrinth seal is made for the fly ashes;
one or more leveling members of the ash bed laid on said slats; and
a transversal interdiction means mounted on said casing upstream of the loading point or points of said conveyor and adapted to prevent a flow of ashes in a direction opposite to that of transport.

49. The apparatus according to claim 48, wherein said slats have a pair of dedicated lateral seats adapted to receive respective bottom edges of said fixed side boards.

50. The apparatus according to claim 48, wherein each of said leveling members is mounted on said casing and is adapted to be arranged at or near a respective loading point of said conveyor, and wherein each of said leveling members extends above said slats in a direction substantially orthogonal thereto.

51. The apparatus according to claim 50, wherein said or each leveling member comprises a fixed or movable gate means.

52. The apparatus according to claim 48, wherein said leveling members are made by ash runners.

53. The apparatus according to claim 48, wherein said leveling members are arranged along said transport path at increasing distance from the transport surface of said belt.

54. The apparatus according to claim 48, wherein said transversal interdiction means comprises a movable transverse baffle.

55. The apparatus according to claim 48, wherein said conveyor comprises a plurality of fines recovery elements for recovering fines from a bottom of the conveyor itself, preferably in form of scrapers associated to the integrated fines recovery system.

56. The apparatus according to claim 55, wherein said transversal interdiction means comprises a movable transverse baffle, and wherein said movable transverse baffle is selectively operable to allow transit of said fines recovery elements.

57. The apparatus according to claim 48, wherein said containment means comprises a plurality of transverse boards integral to said slats and arranged at preset intervals on said slats.

58. The apparatus according to claim 48, wherein said containment means comprises a system allowing to maintain the environment of said conveyor inside said casing under a slight negative pressure with respect to outside environment.

59. The apparatus according to claim 48, wherein the metal conveyor belt comprises a metal mesh supporting a plurality of adjacent or partially overlapped metal slats.
